(19) United States
(12) Patent Application Publication
(10) Pub. No.: US 2025/0348350 A1
(43) Pub. Date: Nov. 13, 2025

(54) SYSTEMS AND METHODS FOR INTEGRATING ANALYTIC DATA WAREHOUSE WITH AN IN-MEMORY DATABASE FOR BATCH AND LIVE STREAMING

(71) Applicant: Fidelity Information Services, LLC, Jacksonville, FL (US)

(72) Inventors: Ranadhir GHOSH, St Johns, FL (US); John PLATAIS, Menomonee Falls, WI (US); Prajwal M, Bengaluru (IN)

(21) Appl. No.: 18/962,621

(22) Filed: Nov. 27, 2024

Related U.S. Application Data
(63) Continuation-in-part of application No. 18/660,359, filed on May 10, 2024.

(51) Int. Cl. G06F 9/48; G06F 9/451

(52) U.S. Cl. CPC G06F 9/4881; G06F 9/451

(57) ABSTRACT

A method for processing batch and live streaming data is disclosed. The method may include receiving a first data object from a data source, the first data object being of information technology event data; processing the first data object; determining, by utilizing a message queue, a first identifier for the first data object; storing the processed first data object in a data sink layer; transferring the first data object to a data warehouse configured to apply an analytic algorithm to the first data object, wherein the transfer is based on the first identifier; determining, by applying the analytic algorithm to the first data object, a third data object; transferring the first data object and third data object to an in-memory database; retrieving and presenting the first data object and/or third data object from the in-memory database to present in a presentation layer of a user interface.

### CROSS-REFERENCE TO RELATED APPLICATION(S)

This patent application is a continuation-in-part of and claims the benefit of priority to U.S. application Ser. No. 18/660,359, filed on May 10, 2024, the entirety of which is incorporated herein by reference.

### TECHNICAL FIELD

Various embodiments of the present disclosure relate generally to information technology (IT) management systems and, more particularly, to systems and methods for integrating analytic data warehouse with an in-memory database for batch and live streaming

### BACKGROUND

In computing systems, for example computing systems that perform financial services and electronic payment transactions, programing changes may occur. For example, software may be updated. Changes in the system may lead to, defects, issues, bugs or problems (collectively referred to as incidents) within the system. These incidents may occur at the time of a software change or at a later time. These incidents may be costly for the company, as users may not be able to use the services, and due to resources expended by the company to resolve the incidents.

These incidents in the system may need to be examined and resolved in order to have the software services perform correctly. Time may be spent by, for example, incident resolution teams, determining what issues arose within the software services. The faster an incident may be resolved, the less potential costs a company may incur. Thus, promptly identifying and fixing such incidents (e.g., writing new code or updating deployed code) may be important to a company.

Data processing pipelines may include delays between data collection and generating insight due to batch processing in conventional systems. The present disclosure is directed to addressing this and other drawbacks to the existing computing system analysis.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

In some aspects, the techniques described herein relate to a method for processing batch and live streaming data, the method including: receiving a first data object and a second data object from a data source, the first data object and second data object being of information technology event data; processing the first data object and second data object; determining, by utilizing a message queue, a first identifier for the first data object and a second identifier for the second data object; storing the processed first data object and second data object in a data sink layer; transferring the first data object to a data warehouse configured to apply an analytic algorithm to the first data object, wherein the transfer is based on the first identifier; determining, by applying the analytic algorithm to the first data object, a third data object; transferring the first data object and third data object to an in-memory database; transferring the second data object to the in-memory database, wherein the transfer is based on the second identifier; and retrieving and presenting the first data object, second data object, and/or third data object from the in-memory database to present in a presentation layer of a user interface.

In some aspects, the techniques described herein relate to a method, wherein the first data object includes incident data, alert data, change data, problem data, or anomaly data.

In some aspects, the techniques described herein relate to a method, wherein the data source is configured to output both a stream of information technology event data and batches of information technology event data.

In some aspects, the techniques described herein relate to a method, wherein processing the first data object and second data object further includes: applying one or more of a lower casing, tokenization, punctuation mark removal, stop word removal, stemming, and/or lemmatization algorithms.

In some aspects, the techniques described herein relate to a method, wherein determining, by utilizing a message queue, a first identifier for the first data object and a second identifier for the second data object further includes: obtaining a first key associated with the first data object and a second key associated with the second data object; applying a hash function to the first key and second key; and identifying the first identifier and the second identifier from the application of the hash function.

In some aspects, the techniques described herein relate to a method, wherein the first identifier is configured to determine a type of analytic algorithm to apply to the first data object.

In some aspects, the techniques described herein relate to a method, further including: applying a query algorithm to the in-memory database to search whether the first identifier and associated first data object has been retrieved by the in-memory database; and upon determining the first identifier and first data object has been retrieved, automatically providing an alert to a third party system.

In some aspects, the techniques described herein relate to a method, wherein the presentation layer may display real-time data and visualization of the received first data object and second data object.

In some aspects, the techniques described herein relate to a system for processing batch and live streaming data, the system including: a memory having processor-readable instructions stored therein; and at least one processor configured to access the memory and execute the processor-readable instructions to perform operations including: receiving a first data object and a second data object from a data source, the first data object and second data object being of information technology event data; processing the first data object and second data object; determining, by utilizing a message queue, a first identifier for the first data object and a second identifier for the second data object; storing the processed first data object and second data object in a data sink layer; transferring the first data object to a data warehouse configured to apply an analytic algorithm to the first data object, wherein the transfer is based on the first identifier; determining, by applying the analytic algorithm to the first data object, a third data object; transferring the first data object and third data object to an in-memory database; transferring the second data object to the in-memory database, wherein the transfer is based on the second identifier; and retrieving and presenting the first data object, second data object, and/or third data object from the in-memory database to present in a presentation layer of a user interface.

In some aspects, the techniques described herein relate to a system, wherein the first data object includes incident data, alert data, change data, problem data, or anomaly data.

In some aspects, the techniques described herein relate to a system, wherein the data source is configured to output both a stream of information technology event data and batches of information technology event data.

In some aspects, the techniques described herein relate to a system, wherein processing the first data object and second data object further includes: applying one or more of a lower casing, tokenization, punctuation mark removal, stop word removal, stemming, and/or lemmatization algorithms.

In some aspects, the techniques described herein relate to a system, wherein determining, by utilizing a message queue, a first identifier for the first data object and a second identifier for the second data object further includes: obtaining a first key associated with the first data object and a second key associated with the second data object; applying a hash function to the first key and second key; and identifying the first identifier and the second identifier from the application of the hash function.

In some aspects, the techniques described herein relate to a system, wherein the first identifier is configured to determine a type of analytic algorithm to apply to the first data object.

In some aspects, the techniques described herein relate to a system, further including: applying a query algorithm to the in-memory database to search whether the first identifier and associated first data object has been retrieved by the in-memory database; and upon determining the first identifier and first data object has been retrieved, automatically providing an alert to a third party system.

In some aspects, the techniques described herein relate to a system, wherein the presentation layer may display real-time data and visualization of the received first data object and second data object.

In some aspects, the techniques described herein relate to a non-transitory computer readable medium storing processor-readable instructions which, when executed by at least one processor, cause the at least one processor to perform operations including: receiving a first data object and a second data object from a data source, the first data object and second data object being of information technology event data; processing the first data object and second data object; determining, by utilizing a message queue, a first identifier for the first data object and a second identifier for the second data object; storing the processed first data object and second data object in a data sink layer; transferring the first data object to a data warehouse configured to apply an analytic algorithm to the first data object, wherein the transfer is based on the first identifier; determining, by applying the analytic algorithm to the first data object, a third data object; transferring the first data object and third data object to an in-memory database; transferring the second data object to the in-memory database, wherein the transfer is based on the second identifier; and retrieving and presenting the first data object, second data object, and/or third data object from the in-memory database to present in a presentation layer of a user interface.

In some aspects, the techniques described herein relate to a non-transitory computer readable medium storing, wherein the first data object includes incident data, alert data, change data, problem data, or anomaly data.

In some aspects, the techniques described herein relate to a non-transitory computer readable medium storing, wherein the data source is configured to output both a stream of information technology event data and batches of information technology event data.

In some aspects, the techniques described herein relate to a non-transitory computer readable medium storing, wherein processing the first data object and second data object further includes: applying one or more of a lower casing, tokenization, punctuation mark removal, stop word removal, stemming, and/or lemmatization algorithms.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate several embodiments and together with the description, serve to explain the principles of the disclosure.

FIG. 1 depicts an exemplary system overview for a data pipeline for an artificial intelligence model to predict and troubleshoot incidents in a system, according to one or more embodiments.

FIG. 2 depicts an exemplary system of an analytic warehouse integrated with a memory database, according to one or more embodiments.

FIG. 3 depicts a flowchart for a method of processing batch and live streaming data, according to one or more embodiments.

FIG. 4 depicts a flowchart for a method of processing batch and live streaming information technology event data, according to one or more embodiments.

FIG. 5 illustrates a computer system for executing the techniques described herein, according to one or more embodiments of the present disclosure.

### DETAILED DESCRIPTION OF EMBODIMENTS

Various embodiments of the present disclosure relate generally to information technology (IT) management systems and, more particularly, to systems and methods for integrating analytic data warehouse with an in-memory database for batch and live streaming

The subject matter of the present disclosure will now be described more fully with reference to the accompanying drawings that show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter may be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

Software companies have been struggling to avoid outages from incidents that may be caused by upgrading software or hardware components, or changing a member of a team, for example. The system described herein may be configured to analyze and/or process event data for an IT system. The system described herein may, for example, receive a stream of event data over periods of time. This event data may further be described as information technology (IT) event data. Event data may include, but is not limited: (1) an incident, (2) an alert, (3) change data, (4) a problem; and/or (5) an anomaly.

An incident may be an occurrence that can disrupt or cause a loss of operation, services, or functions of a system. Incidents may be manually reported by customers or personnel, may be automatically logged by internal systems, or may be captured in other ways. An incident may occur from factors such as hardware failure, software failure, software bugs, human error, and/or cyber attacks. Deploying, refactoring, or releasing software code may, for example, cause an incident. An incident may be detected during, for example, an outage or a performance change. An incident may include characteristics, where an incident characteristic may refer to the quality or traits associated with an incident. For example, incident characteristics may include, but is not limited to, the severity of an incident, the urgency of an incident, the complexity of an incident, the scope of an incident, the cause of an incident, and/or what configurable item corresponds to the incident (e.g., what systems/platforms/products etc. are affected by the incident), how it is described in freeform text, what business segment is affected, what category/subcategory is affected, and/or what assigned group is affected by the incident.

An alert may refer to a notification that informs a system or user of an event. An alert may include notification of a collection of events representing a deviation from normal behavior for a system. For example, an alert may include metadata including a short field description that includes free from text fields (e.g., a summary of the alert), first occurrences, time stamps, an alert key, etc. Understanding the different types of alerts within a system from various perspectives may assist in resolving incidents.

Change data may refer to information that describes a modification made to data within a system or database. Change data may track the changes that occur over one or more periods of time. Problem data may refer to any data that causes issues or impedes a systems normal operations. Anomaly data may refer to data that indicates a deviation of a system from a standard or normal operation.

The event data may further include entities effected by the event and their respective relationships. Event data may be associated with one or more configurable items (CIs). A configurable item (CI) may refer to a component of a system which can be identified as a self-contained unit for purposes of change control and identification.

For example, a particular application, service, particular product, and/or server, may be defined by a CI.

An incident may further be associated with a particular line of business (LOB). The LOB may refer to an assigned category, where the LOB may include association logic linking a LOB with one or more of: business services, service offerings, applications, application instances or web services, and/or servers and services. A LOB may be associated with a variety of CIs.

An IT management system may receive incidents (e.g., data objects indicating occurrences of incidents) at invariable rates throughout the day. When incidents are received, it may be unclear as to how a particular incident relates to previous incidents. Better understanding the relationship between received incidents, in comparison to similar past incidents, may assist a user or a system in identifying and potentially addressing incidents for a system.

Processing a vast amount of information, such as incidents, to produce meaningful and actionable insights in IT operations may be valuable to organizations. As IT management systems utilize sophisticated tools and sensors, billions of data points may be received, and information overload may become an issue to be resolved. It may be challenging to analyze and make sense of heterogeneous and asynchronous IT operations event data. The data may, for example, be complex and difficult to interpret using conventional techniques

Conventional data pipeline systems may involves using separate systems for batch processing and real-time data streaming. Data may be collected and stored in a database or data warehouse, and batch processing may be performed on a scheduled basis to generate insights and reports. Real-time data streaming may be handled by a separate system, which feeds the data into the presentation layer for the user interface (UI). There may be a delay between data collection and generating insights due to batch processing. This can result in data latency, impacting the timeliness of insights and decision-making.

Conventional systems may have performance limitations. Without an in-memory database, the processing speed and performance of the system may be compromised. This can result in slower data retrieval and analysis, leading to delays in generating real-time insights.

Conventional systems may have increased latency. The absence of integration between the data warehouse and in-memory database can introduce additional latency in data processing. This can impact the responsiveness of the UI and hinder real-time data updates.

Conventional systems may have limited scalability. The system described herein may include an in-memory database that allows for efficient handling of large volumes of data, enabling scalability. Without integration, the system may struggle to handle increasing data loads, affecting the overall scalability and capacity of the solution.

Conventional systems may have inconsistent data. Lack of integration between the data warehouse and in-memory database can lead to data inconsistencies. Real-time updates may not be reflected accurately in the presentation layer, resulting in incorrect or outdated information being displayed to users.

Conventional systems may have reduced analytical capabilities. The system described herein may integrate an analytic data warehouse with an in-memory database that allows for advanced analytics and complex queries on large datasets. Without this integration, the system may lack the necessary capabilities to perform sophisticated data analysis and deliver meaningful insights.

One or more embodiments may integrate an analytic data warehouse with in-memory database for batch and live streaming a presentation layer for UI. The analytic data warehouse may be designed to handle large volumes of data and complex queries, making it an ideal choice for storing and analyzing historical data. The in-memory database may be optimized for fast data access and processing, making it a good choice for real-time data streaming.

By integrating these two technologies, the system described herein may leverage the strengths of both to provide a comprehensive solution for your data analytics. The system described herein may provide complex analytics on historical data while also providing real-time insights through the presentation layer for UI. The system may provide a solution for handling both batch and real-time data processing needs.

One or more embodiments may allow for various types of data processing in order to identify correlations, similarity, and root causes, and recommend a corrective action based on received data as well as user feedback mechanisms. One or more embodiments may be extended to clients and users of services and software with applications that are connected to the system described herein.

Any suitable system infrastructure maybe utilized by the system described herein to integrate an analytic data warehouse with in-memory database for batch and live streaming of a presentation layer for a UI. For example, system 100 and system 200 described below may be implemented to perform method 300 and method 400 described herein. The following discussion provide a brief, general description of a suitable computing environment in which the present disclosure may be implemented. In one embodiment, any of the disclosed systems, methods, and/or graphical user interfaces may be executed by or implemented by a computing system. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

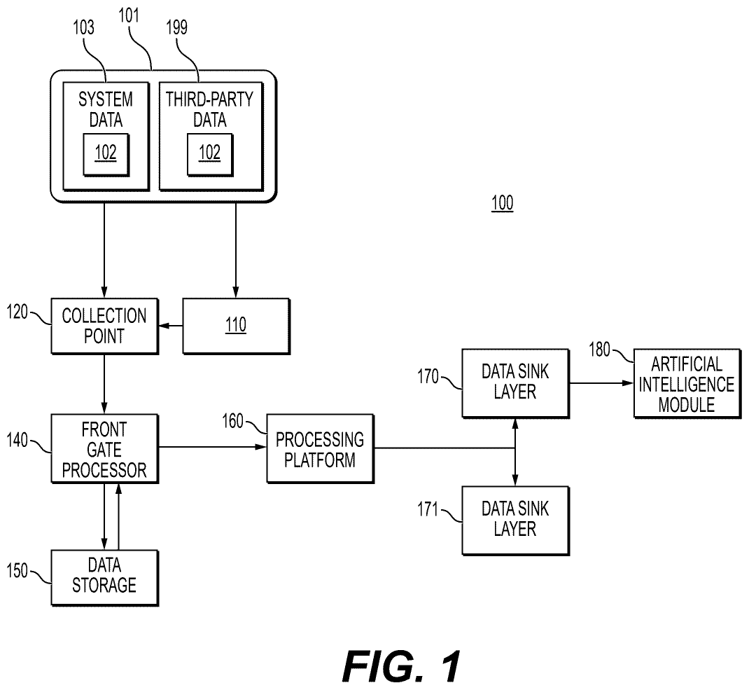

FIG. 1 depicts an exemplary system overview for a data pipeline for an artificial intelligence model to analyze IT data in a system, according to one or more embodiments. For example, the data pipeline system 100, may aggregate and send IT data to a sink layer 170. The data pipeline system 100 may be a platform with multiple interconnected components. The data pipeline system 100 may include one or more servers, intelligent networking devices, computing devices, components, and corresponding software for aggregating and processing data.

As shown in FIG. 1, a data pipeline system 100 may include a data source 101, a collection point 120, a secondary collection point 110, a front gate processor 140, data storage 150, a processing platform 160, a data sink layer 170, a data sink layer 171, and an artificial intelligence module 180.

The data source 101 may include in-house data 103 and third party data 199. The in-house data 103 may be a data source directly linked to the data pipeline system 100. Third party data 199 may be a data source connected to the data pipeline system 100 externally as will be described in greater detail below.

Both the in-house data 103 and third party data 199 of the data source 101 may include incident data 102. Incident data 102 may include incident reports with information for each incident provided with one or more of an incident number, closed date/time, category, close code, close note, long description, short description, root cause, or assignment group. Incident data 102 may include incident reports with information for each incident provided with one or more of an issue key, description, summary, label, issue type, fix version, environment, author, or comments. Incident data 102 may include incident reports with information for each incident provided with one or more of a file name, script name, script type, script description, display identifier, message, committer type, committer link, properties, file changes, or branch information. Incident data 102 may include one or more of real-time data, market data, performance data, historical data, utilization data, infrastructure data, or security data. These are merely examples of information that may be used as data, and the disclosure is not limited to these examples.

Incident data 102 may be generated automatically by monitoring tools that generate alerts and incident data to provide notification of high-risk actions, failures in IT environment, and may be generated as tickets. Incident data may include metadata, such as, for example, text fields, identifying codes, and time stamps.

The in-house data 103 may be stored in a relational database including an incident table. The incident table may be provided as one or more tables, and may include, for example, one or more of problems, tasks, risk conditions, incidents, or changes. The relational database may be stored in a cloud. The relational database may be connected through encryption to a gateway. The relational database may send and receive periodic updates to and from the cloud. The cloud may be a remote cloud service, a local service, or any combination thereof. The cloud may include a gateway connected to a processing API configured to transfer data to the collection point 120 or a secondary collection point 110. The incident table may include incident data 102.

The data pipeline system 100 may include third party data 199 generated and maintained by third party data producers. Third party data producers may produce incident data 102 from Internet of Things (IoT) devices, desktop-level devices, and sensors. Third party data producers may include but are not limited to Tryambak, Appneta, Oracle, Prognosis, ThousandEyes, Zabbix, ServiceNow, Density, Dyatrace, etc. The incident data 102 may include metadata indicating that the data belongs to a particular client or associated system.

The data pipeline system 100 may include a secondary collection point 110 to collect and pre-process the incident data 102 from the data source 101. The secondary collection point 110 may be utilized prior to transferring data to a collection point 120. The secondary collection point 110 point may, for example, be an Apache Minifi software. In one example, the secondary collection point 110 may run on a microprocessor for a third party data producer. Each third party data producer may have an instance of the secondary collection point 110 running on a microprocessor. The secondary collection point 110 may support data formats including but not limited to JSON, CSV, Avro, ORC, HTML, XML, and Parquet. The secondary collection point 110 may encrypt incident data 102 collected from the third party data producers. The secondary collection point 110 may encrypt incident data, including, but not limited to, Mutual Authentication Transport Layer Security (mTLS), HTTPs, SSH, PGP, IPsec, and SSL. The secondary collection point 110 may perform initial transformation or processing of incident data 102. The secondary collection point 110 may be configured to collect data from a variety of protocols, have data provenance generated immediately, apply transformations and encryptions on the data, and prioritize data.

The data pipeline system 100 may include the collection point 120. The collection point 120 may be a system configured to provide a secure framework for routing, transforming, and delivering data across from the data source 101 to downstream processing devices (e.g., a front gate processor 140). The collection point 120 may, for example, be a software such as Apache NiFi. The collection point 120 may receive raw data and the data's corresponding fields such as the source name and ingestion time. The collection point 120 may run on a Linux Virtual Machine (VM) on a remote server. The collection point 120 may include one or more nodes. For example, the collection point 120 may receive incident data 102 directly from the data source 101. In another example, the collection point 120 may receive the incident data 102 from the secondary collection point 110. The secondary collection point 110 may transfer the incident data 102 to the collection point 120 using, for example, Site-to-Site protocol. The collection point 120 may include a flow algorithm. The flow algorithm may connect different processors, as described herein, to transfer and modify data from one source to another. For each third party data producer, the collection point 120 may have a separate flow algorithm. Each flow algorithm may include a processing group. The processing group may include one or more processors. The one or more processors may, for example, fetch the incident data 102 from the relational database. The one or more processors may utilize the processing API of the in-house data 103 to make an API call to a relational database to fetch incident data 102 from the incident table. The one or more processors may further transfer the incident data 102 to a destination system such as a front gate processor 140. The collection point 120 may encrypt data through HTTPS, Mutual Authentication Transport Layer Security (mTLS), SSH, PGP, IPsec, and/or SSL, etc. The collection point 120 may support data formats including but not limited to JSON, CSV, Avro, ORC, HTML, XML, and Parquet. The collection point 120 may be configured to write messages to clusters of a front gate processor 140 and communication with the front gate processor 140.

The data pipeline system 100 may include a distributed event streaming platform such as the front gate processor 140. The front gate processor 140 may be connected to and configured to receive data from the collection point 120. The front gate processor 140 may be implemented in an Apache Kafka cluster software system. The front gate processor 140 may include one or more message brokers and corresponding nodes. The message broker may, for example, be an intermediary computer program module that translates a message from the formal messaging protocol of the sender to the formal messaging protocol of the receiver. The message broker may be on a single node in the front gate processor 140. A message broker of the front gate processor 140 may run on a virtual machine (VM) on a remote server. The collection point 120 may send the incident data 102 to one or more of the message brokers of the front gate processor 140. Each message broker may include a topic to store similar categories of incident data 102. A topic may be an ordered log of events. Each topic may include one or more sub-topics. For example, one sub-topic may store the incident data 102 relating to network problems, and another sub-topic may store the incident data 102 related to security breaches from third party data producers. Each topic may further include one or more partitions. The partitions may be a systematic way of breaking the one topic log file into many logs, each of which can be hosted on a separate server. Each partition may be configured to store as much as a byte of the incident data 102. Each topic may be partitioned evenly between one or more message brokers to achieve load balancing and scalability. The front gate processor 140 may be configured to categorize the received data into a plurality of client categories, thereby forming a plurality of datasets associated with the respective client categories. These datasets may be stored separately within the storage device as described in greater detail below. The front gate processor 140 may further transfer data to storage and to processors for further processing.

For example, the front gate processor 140 may be configured to assign particular data to a corresponding topic. Alert sources may be assigned to an alert topic, and the incident data 102 may be assigned to an incident topic. Change data may be assigned to a change topic. Problem data may be assigned to a problem topic.

The data pipeline system 100 may include a software framework for data storage 150. The data storage 150 may be configured for long term storage and distributed processing. The data storage 150 may be implemented using, for example, Apache Hadoop. The data storage 150 may store the incident data 102 transferred from the front gate processor 140. In particular, the data storage 150 may be utilized for distributed processing of the incident data 102, and Hadoop distributed file system (HDFS) within the data storage may be used for organizing communications and storage of the incident data 102. For example, the HDFS may replicate any node from the front gate processor 140. This replication may protect against hardware or software failures of the front gate processor 140. The processing may be performed in parallel on multiple servers simultaneously.

The data storage 150 may include an HDFS that is configured to receive the metadata (e.g., incident data). The data storage 150 may further apply an algorithm to process the data. This processing may allow for parallel processing of large data sets. This algorithm may be implemented by a MapReduce algorithm, for example. The data storage 150 may further aggregate and store the data. Algorithms within data storage 150 may be used for cluster resource management and planning tasks of the stored data. The algorithm may, for example, be Yet Another Resource Negotiation (YARN). For example, a cluster computing framework, such as the processing platform 160, may be arranged to further utilize the HDFS of the data storage 150. For example, if the data source 101 stops providing data, the processing platform 160 may be configured to retrieve data from the data storage 150 either directly or through the front gate processor 140. The data storage 150 may allow for the distributed processing of large data sets across clusters of computers using programming models. The data storage 150 may include a master node and an HDFS for distributing processing across a plurality of data nodes. The master node may store metadata such as the number of blocks and their locations. The main node may maintain the file system namespace and regulate client access to said files. The main node may comprise files and directories and perform file system executions such as naming, closing, and opening files. The data storage 150 may scale up from a single server to thousands of machines, each offering local computation and storage. The data storage 150 may be configured to store the incident data 102 in an unstructured, semi-structured, or structured form. In one example, the plurality of datasets associated with the respective client categories may be stored separately. The master node may store the metadata such as the separate dataset locations.

The data pipeline system 100 may include a real-time processing framework, e.g., a processing platform 160. In one example, the processing platform 160 may be a distributed dataflow engine that does not have its own storage layer. For example, this may be the software platform Apache Flink. In another example, the software platform Apache Spark may be utilized. The processing platform 160 may support stream processing and batch processing. Stream processing may be a type of data processing that performs continuous, real-time analysis of received data. Batch processing may involve receiving discrete data sets processed in batches. The processing platform 160 may include one or more nodes. The processing platform 160 may aggregate incident data 102 (e.g., incident data 102 that has been processed by the front gate processor 140) received from the front gate processor 140. The processing platform 160 may include one or more operators to transform and process the received data. For example, a single operator may filter the incident data 102 and then connect to another operator to perform further data transformation. The processing platform 160 may process incident data 102 in parallel. A single operator may be on a single node within the processing platform 160. The processing platform 160 may be configured to filter and only send particular processed data to a particular data sink layer. For example, depending on the data source of the incident data 102 (e.g., whether the data is in-house data 103 or third party data 199), the data may be transferred to a separate data sink layer (e.g., the data sink layer 170, or the data sink layer 171). Further, additional data that is not required at downstream modules (e.g., at the artificial intelligence module 180) may be filtered and excluded prior to transferring the data to a data sink layer.

The processing platform 160 may perform three functions. First, the processing platform 160 may perform data validation. The data's value, structure, and/or format may be matched with the schema of the destination (e.g., the data sink layer 170). Second, the processing platform 160 may perform a data transformation. For example, a source field, target field, function, and parameter from the data may be extracted. Based upon the extracted function of the data, a particular transformation may be applied. The transformation may reformat the data for a particular use downstream. A user may be able to select a particular format for downstream use. Third, the processing platform 160 may perform data routing. For example, the processing platform 160 may select the shortest and/or most reliable path to send data to a respective sink layer (e.g., the data sink layer 170 and/or the data sink layer 171).

In one example, the processing platform 160 may be configured to transfer particular sets of data to a data sink layer (e.g., the data sink layer 170 and/or the data sink layer 171). For example, the processing platform 160 may receive input variables for a particular artificial intelligence module 180. The processing platform 160 may then filter the data received from the front gate processor 140 and only transfer data related to the input variables of the artificial intelligence module 180 to a data sink layer (e.g., the data sink layer 170 and/or the data sink layer 171).

The data pipeline system 100 may include the one or more data sink layers (e.g., data sink layer 170 and data sink layer 171). Incident data 102 processed from processing platform 160 may be transmitted to and stored in the data sink layer 170. In one example, the data sink layer 171 may be stored externally on a particular client's server. The data sink layer 170 and data sink layer 171 may be implemented using a software such as, but not limited to, PostgreSQL, HIVE, Kafka, OpenSearch, and Neo4j. The data sink layer 170 may receive in-house data 103, which have been processed and received from the processing platform 160. The data sink layer 171 may receive third party data 199, which have been processed and received from the processing platform 160. The data sink layers may be configured to transfer incident data 102 to an artificial intelligence module 180. The data sink layers (e.g., the data sink layer 170 and/or the data sink layer 171) may be data lakes, data warehouses, or cloud storage systems. Each data sink layer (e.g., the data sink layer 170 and/or the data sink layer 171) may be configured to store incident data 102 in both a structured or unstructured format. The data sink layer 170 may store incident data 102 with several different formats. For example, the data sink layer 170 may support data formats such as JavaScript Objection Notation (JSON), comma-separated value (CSV), Avro, Optimized Row Columnar (ORC), Hypertext Markup Language (HTML), Extensible Markup Language (XML), or Parquet, etc. The data sink layer (e.g., data sink layer 170 or data sink layer 171), may be accessed by one or more separate components. For example, the data sink layer may be accessed by a Non-structured Query language (“NoSQL”) database management system (e.g., a Cassandra cluster), a graph database management system (e.g., Neo4j cluster), further processing programs (e.g., Kafka+Flink programs), and a relation database management system (e.g., postgres cluster). Further processing may thus be performed prior to the processed data being received by the artificial intelligence module 180.

The data pipeline system 100 may include the artificial intelligence module 180. The artificial intelligence module 180 may include a machine-learning component. The artificial intelligence module 180 may use the received data in order to train and/or use a machine learning model. The artificial intelligence module 180 may be, for example, a neural network. Nonetheless, it should be noted that other machine learning techniques and frameworks may be used by the artificial intelligence module 180 to perform the methods contemplated by the present disclosure. For example, the systems and methods may be realized using other types of supervised and unsupervised machine learning techniques such as regression problems, random forest, cluster algorithms, principal component analysis (PCA), reinforcement learning, or a combination thereof. The artificial intelligence module 180 may be configured to extract and receive data from the data sink layer 170.

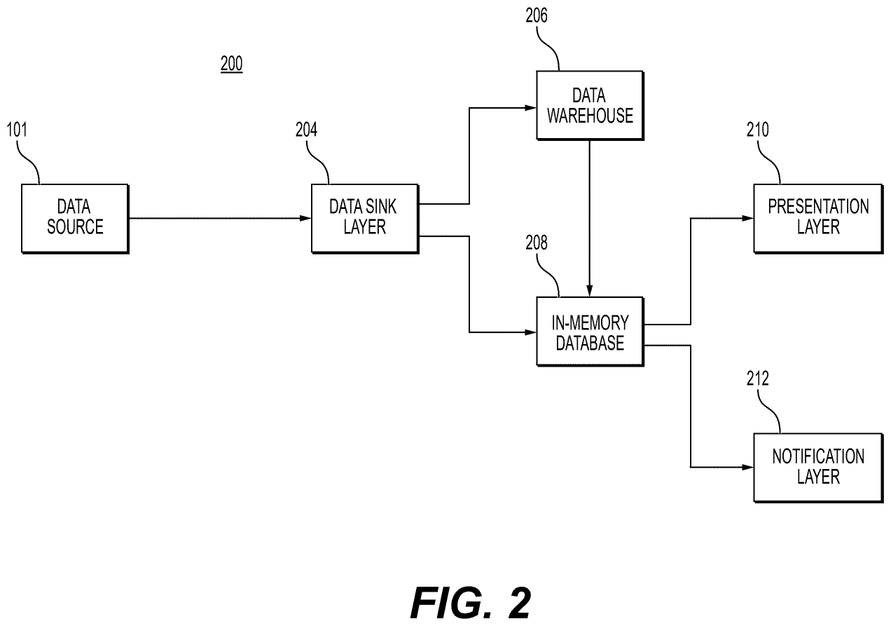

FIG. 2 depicts an exemplary system 200 of a data warehouse 206 integrated with an In-Memory database 208, according to an embodiments. The exemplary system 200 may be implemented, either in part or in its entirety, by the system 100 of FIG. 1. The system 200 may include a data source 101, a data sink layer 204, a data warehouse 206, an In-Memory database 208, and a notification layer 212.

The system 200 may include data source 101 as described above in FIG. 1. The data source 101 may be configured to output data objects representing IT events. The data objects may include corresponding metadata associated with the data objects. The system 200 may further include one or more processing modules 202 (e.g., processing platform 160 of FIG. 1) configured to process the received data. The processing modules may be configured to apply extraction algorithms, transformation algorithms, and/or load algorithms.

The system 200 may further include a data sink layer 204. The data sink layer 204 may, for example, be the data sink layer 170 of FIG. 1. The data sink layer 204 may include a set of data sink layers. The data sink layer 204 may be configured to receive and store =processed data (e.g., from the one or more processing modules 202). The data sink layer 204 may act as a distributed streaming platform that handles high-throughput, fault-tolerant, and real-time data streaming. For example, the data sink layer 204 may be implemented by Kafka or by Apache Cassandra. The data sink layer 204 may be configured to load data to the data warehouse 206 and In-Memory database 208 described below. The data sink layer 204 may be configured to upload data to each component (e.g., the data warehouse 206 and In-Memory database 208) simultaneously.

The system 200 may further include a message queue. The message queue may be configured to organize the received data object into topics. The message queue may further include channels that that may interact with each component of the system 200. The message queue may, for example, be implemented by a distributed streaming platform such as Apache Kafka. The topics of the message queue may include partitions. The message queue may further include producers configured to send messages to specific topics, and each message may be assigned a unique identifier. The unique identifier may, for example, be utilized within the system 200 to assist with providing information as to where to distribute data from the data sink layer 204. The message queue may include one or more configuration files that include the business logic of how a data object should be analyzed and what components a data object should be transferred to. For example, the message queue may be configured to transfer time sensitive data directly to the data warehouse 206 for immediate processing. In another example, the configuration file may indicate that a data object should be transferred to the data warehouse 206 and further indicate which analysis should be applied to the data object. In some examples, this may include applying various machine learning techniques to the metadata associated with the data object. In exemplary cases, this may include applying machine learning systems to associate data objects representing received incidents, with similar incidents that have occurred in the past.

The system 200 may further include a data warehouse 206. The data warehouse 206 may be an analytic data warehouse that is designed to handle large volumes of data and complex queries. It may be configured to analyze historical IT event data. The data warehouse 206 may be configured to receive data from the data sink layer 204. The data may be assigned to be transferred from the data sink layer 204 to the data warehouse 206 by the message queue. The configuration file may indicate, based on a data objects assigned unique identifier, whether to transfer the data object to the data warehouse and what particular algorithms to apply to the data object. The data warehouse 206 may apply analytics on the received data. Further, the data warehouse 206, may, upon applying one or more algorithms to received data (e.g., data from the sink layer 204), create additional data object outputs. These outputs may be retrieved by the In-Memory database 208 and utilized for further analysis. The data warehouse 206 may be implemented by the Apache Hive and may implement PySpark. For example, PySpark may be implemented to process and load data from the data sink layer 204. In an exemplary use case, the data warehouse 206 may be configured to analyze data for a received incident and to determine historically similar incidents. For example, the data warehouse 206 may be configured to analyze short descriptions of the received incidents.

One or more machine learning models (e.g., from the machine learning module 180) may be configured to access data object and apply one or more machine learning techniques to the data of the analytic data warehouse 206. In some examples, earlier modules (e.g., the processing module 202 and data sink layers 204) may not be compatible with external machine learning models. Incorporating machine learning models may slow down and decrease the function of these modules. By having the machine learning models access the data through the analytic data warehouse 206, the earlier modules may proceed with their functions more efficiently.

The system 200 may further include In-Memory database 208. The In-Memory database 208 may be optimized for fast data access and processing, allowing for real-time data streaming. The In-Memory database 208 may include in-memory storage (e.g., in random access memory (RAM)) and offer a variety of data structures (e.g., strings, lists, hashes, sets, sorted sets, HyperLogLogs, and Geospatial indexes). The In-Memory database 208 may allow for fast storage and retrieval of data by keeping it in-memory, facilitating real-time data access. In the In-Memory database 208 may be implemented by Redis software, while also implementing PySpark for live streaming data. PySpark may enable seamless integration with Redis for efficient data streaming. Redis may allow for fast storage and retrieval of data by keeping it in-memory, facilitating real-time data access.

As the system 200 implements both a data warehouse 206 and an In-Memory database 208, the system 200 may be configured to handle both batch and real-time data processing. The system 200 may be configured to simultaneously transfer data to both the data warehouse 206 and the In-Memory database 208 based on the assigned identifier associated with data in the data sink layer 204.

The system 200 may further include a presentation layer 210. The presentation layer 210 may be configured to implement a query language (e.g., GraphQL) to access data from the In-Memory database 208. The query language may be flexible and provide an efficient way to retrieve specific data from the In-Memory database 208 based on a particular user interface of the presentation layer's 210 requirements. The query language may be configured to retrieve specific data based on a particular presentation layer's 210 requirements. For example, the presentation layer 210 may allow for users to specify exact types of data required for presentation. The query language may include a scheme type that defines object's and the relationship between the objects. The query language may include a scheme to describe the shape of the available data (e.g., data located in the In-Memory database 208). The schema may define a hierarchy of types with fields that are populated from the available data. The schema may further specify which queries and mutations may be executed for a particular presentation layer 210 setting.

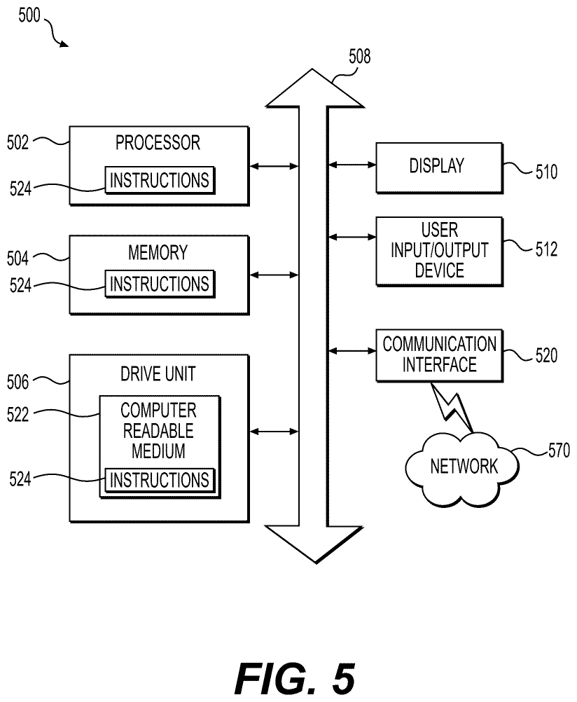

The presentation layer 210 may be a layer in a web application or any user interface that interacts with the end-users. The user interface may display real-time data, visualization, or any other relevant information pulled from the data stored in the In-Memory database 208. For example, data analyzed by the data warehouse 206 may be presented to a user device through the presentation layer 210. The user device may include a computing device as described in FIG. 5 below.

The system 200 may further include a notification layer 212. The notification layer 212 may include one or more data processing components or servers configured to query the In-Memory database 208 for particular updates or new data. The notification layer 212 may be configured to alert an additional system or user when time sensitive or flagged data is received. For example, when a major incident is detected, the notification layer may automatically pull the data from this update and provide a notification to one or more additional servers. The notification layer 212 may be configured to provide data to correspond with any outputted alert.

One or more embodiments of system 200 may allow for efficient data flow that supports real-time streaming, analytics with fast access to data through the In-Memory database 208 and flexible data retrieval applying the graph query language. The system 200 architecture may facilitate seamless integration of various components to deliver real-time data insights to the presentation layer for the user interface of the presentation layer 210.

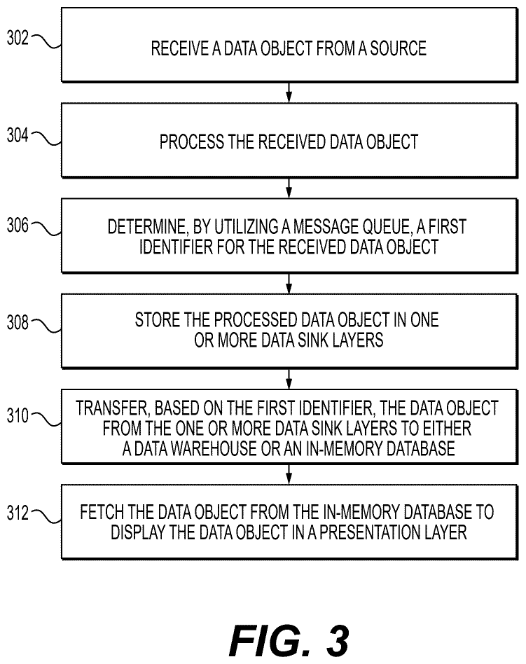

FIG. 3 depicts a flowchart for a method 300 of processing batch and live streaming data, according to one or more embodiments. The method described in FIG. 3 may be implemented by the data pipeline system 100 of FIG. 1 and/or by the system 200 of FIG. 2. The method 300 may be utilized to process data utilizing an analytic data warehouse and an in-memory database simultaneously, wherein the processed data is received as batch and/or stream data.

Step 302 may include receiving a data object from a data source. For example, the received data may be IT event data such as incident data, alert change data, problem; and/or anomaly data. This data may be received in the form of data objects. The IT event data may further include corresponding metadata. The corresponding information may include identifiers, data and time stamps, priority levels, corresponding configurable items associated with the event, short descriptions of the event data. The metadata may be represented as fields of the received data object. The received data object may be received as an individual piece of data in a batch of data, or as a singular piece of data as part of a stream of data.

Step 304 may include processing the received data object. Processing the data object may include applying extraction algorithms, transformation algorithms, and/or load algorithms. For example, the data may be extracted from various sources and transformed into a suitable format prior to further processing. For example, text processing algorithms may be applied on the received data. Exemplary algorithms that may be applied include, but are not limited to, lower casing, tokenization, punctuation mark removal, stop word removal, stemming, and/or lemmatization algorithms. The lower casing algorithm may convert all uppercase characters to lower case. The tokenization algorithm may break the text (e.g., words, numbers, characters, etc.) into smaller unit (e.g., tokens). The output may be a list or sequences of tokens. The punctuation mark removal algorithm may be configured to find and remove any punctuation marks from the text. The stop word removal algorithm may identify and eliminate frequently occurring words with low semantic meaning. For example, this may include the removal of words such as “a”, “the,” “is,” “in,” etc. The stemming algorithm may reduce words to their base or root form. The algorithm may remove suffixes from term (e.g., the term running may be converted to “run). The Lemmatization algorithm may reduce words to their base or dictionary form. The algorithm may lever a morphological dictionary and map inflected words to their respective lemmas. The tokenization algorithm may be the last processing algorithm applied to the received data. The punctuation and stop removal algorithms may be applied first.

Step 306 may include determining, by utilizing a message queue, a first identifier for the received data object from step 304. In exemplary scenarios, step 306 may be performed prior to, simultaneously, or after the processing performed at step 304. In some examples, the collection point 120 may assign the identifier to the data object when received. The identifier may be utilized to assign the received data object to a particular partition within a particular topic. For example, the received data object may include a key associated with the data object, wherein the key was assigned to the data object at the data source or during processing. The message queue may apply a hash function to the key to determine the respective partition to assign the particular data object.

Step 308 may include storing the processed data object in one or more data sink layers (e.g., data sink layer 204). For example, the processed data object may be stored in a particular topic based on the assigned first identifier.

Step 310 may include transferring, based on the first identifier, the data object from the one or more data sink layers to either the data warehouse (e.g., data warehouse 206) or the in-memory database (e.g., In-Memory database 208). This may, for example, separate the data object based on the speed at which the data object has been assigned to be processed. In some examples, a message queue may include a configuration file in a log format, wherein the configuration file indicates, where to transfer and what transformations to apply to each data object based upon the first identifier.

If the data object is assigned to the data warehouse (e.g., based on the configuration files indication of where to transfer data objects with the particular identifier), then the data object may be sent to the data warehouse, where the data warehouse may apply one or more analytic algorithms on the received data object. The analysis may be applied to particular metadata associated with the data object. The first identifier may further indicate the types of analysis to be performed upon the received data object and the data object's respective metadata. This may include algorithms designed to assist with resolving issues related to the originally received IT event data object. This may further include algorithms designed to group and organized data objects. For example, analysis of descriptions of IT event data may be performed such as clustering techniques. Upon applying one or more analytic algorithms to the received data object, the analyzed data may then be transferred to the in-memory database. In some examples, new data object (e.g., a second data object) may be created based on the output of the analytic algorithms applied by the data warehouse. For example, if a data object may be assigned to a particular cluster (e.g., a particular incident may be assigned to a cluster of similar historical incidents), this may be saved as a second data object. The newly created data objects may further be transferred to the in-memory database. In some cases, the newly created data may be saved as particular metadata and stored as a field associated with the data object, rather than as separate data objects.

If the first data object is assigned to the in-memory database (e.g., based on the first identifier and configuration file), then the data object may be sent directly to the in-memory database. The in-memory database may facilitates real-time data access (e.g., by a presentation layer 210). In some examples, the data object may transfer through the data warehouse, have no action or analysis performed, and immediately be transferred to the in-memory database, rather than transferring directly to the in-memory database.

Step 312 may include, fetching the data object from the in-memory database to display the data object in a presentation layer (e.g., the presentation layer 210). The data object may have been previously processed and/or analyzed (e.g., by the data warehouse 206). In some examples, the presentation layer may apply a query language to retrieve the data from the in-memory database. The query language may extract the analyzed data object from step 310. In some examples, the presentation layer may retrieve multiple data objects simultaneously from in-memory database. For example, a presentation layer may extract all major incidents that occurred over a set period of time and present this information to a user or second system. The presentation layer may further, utilize or compile received data object and output the compilation of the data to a user. The user interface may be of a screen of a computer or server.

The method may further include querying, by a separate alert system, the in-memory database to determine when new data and updated data is received. Upon determining that a particular new data object is received, or that a particular data object is updated, the alert system may provide a notification to a separate system of the new or updated object. This alert may include the new or updated data.

The method 300 of FIG. 3 may be applied to multiple data objects simultaneously by implementing the system 200 of FIG. 2. The method 300 may be applied to data objects from both received batches of data and also from constant streams of data.

In an exemplary scenario, a major incident for an external system may occur. Data related to this major incident may automatically be captured and stored (e.g., as data objects as part of data source). As the major incident occurs, a topic in the message queue may be created (e.g., by a listener that determines when a new major incident occurs). The data sink layer may receive the metadata with the major incident and transfer time sensitive data such as the short description of the incident to the data warehouse 206 for time sensitive processing, while transferring other less time sensitive aspects of the event data to the In-Memory database 208. The analysis created by the data warehouse may be retrieved along with the originally received data from the in-memory database and presented to a user through a presentation layer.

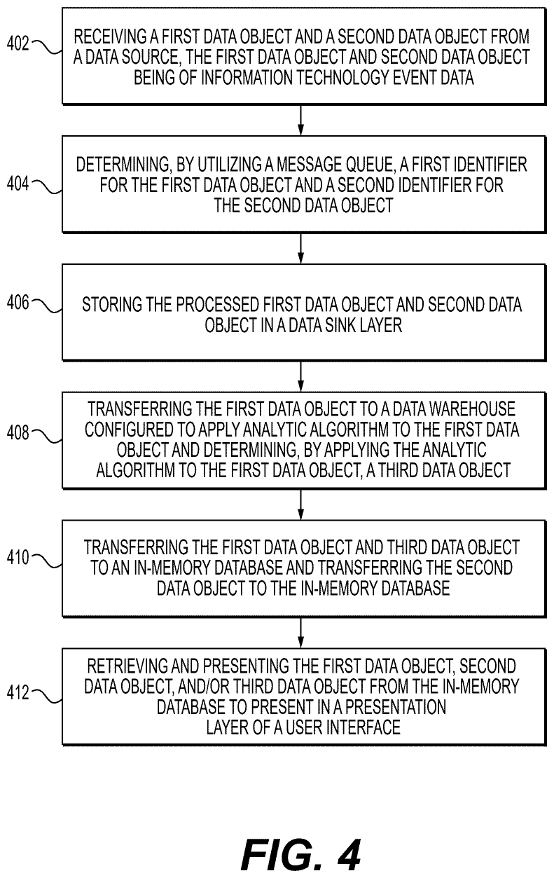

FIG. 4 depicts a flowchart for a method 400 of processing batch and live streaming information technology event data, according to one or more embodiments. The method 400 described in FIG. 4 may be implemented by the data pipeline system 100 of FIG. 1 and/or by the system 200 of FIG. 2.

Step 402 may include receiving a first data object and a second data object from a data source, the first data object and second data object being of information technology event data. The first data object and the second data object may include incident data, alert data, change data, problem data, or anomaly data. The data may be configured to output both a stream of information technology event data and batches of information technology event data.

The method may further include processing the first data object and second data object. This may include applying one or more of a lower casing, tokenization, punctuation mark removal, stop word removal, stemming, and/or lemmatization algorithms to the first data object and/or the second data object.

Step 404 may include determining, by utilizing a message queue, a first identifier for the first data object and a second identifier for the second data object. This may include obtaining a first key associated with the first data object and a second key associated with the second data object; applying a hash function to the first key and second key; and identifying the first identifier and the second identifier from the application of the hash function. The first identifier may be configured to determine a type of analytic algorithm to apply to the first data object. Further, this may include reading a configuration file to determine the type of analytic algorithm to apply for the first identifier.

Step 406 may include storing the processed first data object and second data object in a data sink layer.

Step 408 may include transferring the first data object to a data warehouse configured to apply an analytic algorithm to the first data object and determining, by applying the analytic algorithm to the first data object, a third data object. The transfer may be based on the first identifier.

Step 410 may include transferring the first data object and third data object to an in-memory database and transferring the second data object to the in-memory database. The transfer may be based on the second identifier.

Step 412 may include retrieving and presenting the first data object, second data object, and/or third data object from the in-memory database to present in a presentation layer of a user interface.

The method may further include applying a query algorithm to the in-memory database to search whether the first identifier and associated first data object has been retrieved by the in-memory database; and upon determining the first identifier and first data object has been retrieved, automatically providing an alert to a third party system.

As illustrated in FIG. 5, the computer system 500 may include a processor 502, e.g., a central processing unit (CPU), a graphics processing unit (GPU), or both. The processor 502 may be a component in a variety of systems. For example, the processor 502 may be part of a standard personal computer or a workstation. The processor 502 may be one or more general processors, digital signal processors, application specific integrated circuits, field programmable gate arrays, servers, networks, digital circuits, analog circuits, combinations thereof, or other now known or later developed devices for analyzing and processing data. The processor 502 may implement a software program, such as code generated manually (i.e., programmed).

The computer system 500 may include a memory 504 that can communicate via a bus 508. The memory 504 may be a main memory, a static memory, or a dynamic memory. The memory 504 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 504 includes a cache or random-access memory for the processor 502. In alternative implementations, the memory 504 is separate from the processor 502, such as a cache memory of a processor, the system memory, or other memory. The memory 504 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 504 is operable to store instructions executable by the processor 502. The functions, acts or tasks illustrated in the figures or described herein may be performed by the programmed processor 502 executing the instructions stored in the memory 504. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel payment and the like.

As shown, the computer system 500 may further include a display unit 510, such as a liquid crystal display (LCD), an organic light emitting diode (OLED), a flat panel display, a solid-state display, a cathode ray tube (CRT), a projector, a printer or other now known or later developed display device for outputting determined information. The display 510 may act as an interface for the user to see the functioning of the processor 502, or specifically as an interface with the software stored in the memory 504 or in the drive unit 506.

Additionally or alternatively, the computer system 500 may include an input device 512 configured to allow a user to interact with any of the components of system 500. The input device 512 may be a number pad, a keyboard, or a cursor control device, such as a mouse, or a joystick, touch screen display, remote control, or any other device operative to interact with the computer system 500.

The computer system 500 may also or alternatively include a disk or optical drive unit 506. The disk drive unit 506 may include a computer-readable medium 522 in which one or more sets of instructions 524, e.g., software, can be embedded. Further, the instructions 524 may embody one or more of the methods or logic as described herein. The instructions 524 may reside completely or partially within the memory 504 and/or within the processor 502 during execution by the computer system 500. The memory 504 and the processor 502 also may include computer-readable media as discussed above.

In some systems, a computer-readable medium 522 includes instructions 524 or receives and executes instructions 524 responsive to a propagated signal so that a device connected to a network 570 can communicate voice, video, audio, images, or any other data over the network 570. Further, the instructions 524 may be transmitted or received over the network 570 via a communication port or interface 520, and/or using a bus 508. The communication port or interface 520 may be a part of the processor 502 or may be a separate component. The communication port 520 may be created in software or may be a physical connection in hardware. The communication port 520 may be configured to connect with a network 570, external media, the display 510, or any other components in system 500, or combinations thereof. The connection with the network 570 may be a physical connection, such as a wired Ethernet connection or may be established wirelessly as discussed below. Likewise, the additional connections with other components of the system 500 may be physical connections or may be established wirelessly. The network 570 may alternatively be directly connected to the bus 508.

While the computer-readable medium 522 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 522 may be non-transitory, and may be tangible.

The computer-readable medium 522 can include a solid-state memory such as a memory card or other package that houses one or more non-volatile read-only memories. The computer-readable medium 522 can be a random-access memory or other volatile re-writable memory. Additionally or alternatively, the computer-readable medium 522 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The computer system 500 may be connected to one or more networks 570. The network 570 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 570 may include wide area networks (WAN), such as the Internet, local area networks (LAN), campus area networks, metropolitan area networks, a direct connection such as through a Universal Serial Bus (USB) port, or any other networks that may allow for data communication. The network 570 may be configured to couple one computing device to another computing device to enable communication of data between the devices. The network 570 may generally be enabled to employ any form of machine-readable media for communicating information from one device to another. The network 570 may include communication methods by which information may travel between computing devices. The network 570 may be divided into sub-networks. The sub-networks may allow access to all of the other components connected thereto or the sub-networks may restrict access between the components. The network 570 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel payment. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP, etc.) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosed embodiments are not limited to any particular implementation or programming technique and that the disclosed embodiments may be implemented using any appropriate techniques for implementing the functionality described herein. The disclosed embodiments are not limited to any particular programming language or operating system.

It should be appreciated that in the above description of exemplary embodiments, various features of the embodiments are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that a claimed embodiment requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment.

Furthermore, while some embodiments described herein include some but not other features included in other embodiments, combinations of features of different embodiments are meant to be within the scope of the present disclosure, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the function.

In the description provided herein, numerous specific details are set forth. However, it is understood that embodiments of the present disclosure may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the present disclosure, those skilled in the art will recognize that other and further modifications may be made thereto without departing from the spirit of the present disclosure, and it is intended to claim all such changes and modifications as falling within the scope of the present disclosure. For example, any formulas given above are merely representative of procedures that may be used. Functionality may be added or deleted from the block diagrams and operations may be interchanged among functional blocks. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

What is claimed is:

1. A computer-implemented method for processing batch and live streaming data, the method comprising:
receiving a first data object and a second data object from a data source, the first data object and second data object being of information technology event data;
processing the first data object and second data object;
determining, by utilizing a message queue, a first identifier for the first data object and a second identifier for the second data object;
storing the processed first data object and second data object in a data sink layer;
transferring the first data object to a data warehouse configured to apply an analytic algorithm to the first data object, wherein the transfer is based on the first identifier;
determining, by applying the analytic algorithm to the first data object, a third data object;
transferring the first data object and third data object to an in-memory database;
transferring the second data object to the in-memory database, wherein the transfer is based on the second identifier; and
retrieving and presenting the first data object, second data object, and/or third data object from the in-memory database to present in a presentation layer of a user interface.

2. The method of claim 1, wherein the first data object includes incident data, alert data, change data, problem data, or anomaly data.

3. The method of claim 1, wherein the data source is configured to output both a stream of information technology event data and batches of information technology event data.

4. The method of claim 1, wherein processing the first data object and second data object further includes:
applying one or more of a lower casing, tokenization, punctuation mark removal, stop word removal, stemming, and/or lemmatization algorithms.

5. The method of claim 1, wherein determining, by utilizing a message queue, a first identifier for the first data object and a second identifier for the second data object further includes:
obtaining a first key associated with the first data object and a second key associated with the second data object;
applying a hash function to the first key and second key; and
identifying the first identifier and the second identifier from the applying of the hash function.

6. The method of claim 1, wherein the first identifier is configured to determine a type of analytic algorithm to apply to the first data object.

7. The method of claim 1, further including:
applying a query algorithm to the in-memory database to search whether the first identifier and associated first data object has been retrieved by the in-memory database; and
upon determining the first identifier and first data object has been retrieved, automatically providing an alert to a third party system.

8. The method of claim 1, wherein the presentation layer may display real-time data and visualization of the received first data object and second data object.

9. A system for processing batch and live streaming data, the system comprising:
a memory having processor-readable instructions stored therein; and
at least one processor configured to access the memory and execute the processor-readable instructions to perform operations including:
receiving a first data object and a second data object from a data source, the first data object and second data object being of information technology event data;
processing the first data object and second data object;
determining, by utilizing a message queue, a first identifier for the first data object and a second identifier for the second data object;
storing the processed first data object and second data object in a data sink layer;
transferring the first data object to a data warehouse configured to apply an analytic algorithm to the first data object, wherein the transfer is based on the first identifier;
determining, by applying the analytic algorithm to the first data object, a third data object;
transferring the first data object and third data object to an in-memory database;
transferring the second data object to the in-memory database, wherein the transfer is based on the second identifier; and
retrieving and presenting the first data object, second data object, and/or third data object from the in-memory database to present in a presentation layer of a user interface.

10. The system of claim 9, wherein the first data object includes incident data, alert data, change data, problem data, or anomaly data.

11. The system of claim 9, wherein the data source is configured to output both a stream of information technology event data and batches of information technology event data.

12. The system of claim 9, wherein processing the first data object and second data object further includes:
applying one or more of a lower casing, tokenization, punctuation mark removal, stop word removal, stemming, and/or lemmatization algorithms.

13. The system of claim 9, wherein determining, by utilizing a message queue, a first identifier for the first data object and a second identifier for the second data object further includes:
obtaining a first key associated with the first data object and a second key associated with the second data object;
applying a hash function to the first key and second key; and
identifying the first identifier and the second identifier from the applying of the hash function.

14. The system of claim 9, wherein the first identifier is configured to determine a type of analytic algorithm to apply to the first data object.

15. The system of claim 9, further including:
applying a query algorithm to the in-memory database to search whether the first identifier and associated first data object has been retrieved by the in-memory database; and
upon determining the first identifier and first data object has been retrieved, automatically providing an alert to a third party system.

16. The system of claim 9, wherein the presentation layer may display real-time data and visualization of the received first data object and second data object.

17. A non-transitory computer readable medium storing processor-readable instructions which, when executed by at least one processor, cause the at least one processor to perform operations including:
receiving a first data object and a second data object from a data source, the first data object and second data object being of information technology event data;
processing the first data object and second data object;
determining, by utilizing a message queue, a first identifier for the first data object and a second identifier for the second data object;
storing the processed first data object and second data object in a data sink layer;
transferring the first data object to a data warehouse configured to apply an analytic algorithm to the first data object, wherein the transfer is based on the first identifier;
determining, by applying the analytic algorithm to the first data object, a third data object;
transferring the first data object and third data object to an in-memory database;
transferring the second data object to the in-memory database, wherein the transfer is based on the second identifier; and
retrieving and presenting the first data object, second data object, and/or third data object from the in-memory database to present in a presentation layer of a user interface.

18. The non-transitory computer readable medium of claim 17, wherein the first data object includes incident data, alert data, change data, problem data, or anomaly data.

19. The non-transitory computer readable medium of claim 17, wherein the data source is configured to output both a stream of information technology event data and batches of information technology event data.

20. The non-transitory computer readable medium of claim 17, wherein processing the first data object and second data object further includes:
applying one or more of a lower casing, tokenization, punctuation mark removal, stop word removal, stemming, and/or lemmatization algorithms.
